(19) United States
(12) Patent Application Publication
(10) Pub. No.: US 2005/0094221 A1
(43) Pub. Date: May 5, 2005

(54) Scanner

(75) Inventor: Tsung-Te Lin, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/977,902

(22) Filed: Oct. 29, 2004

(30) Foreign Application Priority Data
Oct. 30, 2003 (TW) TW92219270

(51) Int. Cl. H04N 1/04; H04N 1/10

(52) U.S. Cl. 358/474; 358/497

(57) ABSTRACT

A scanner for scanning an object is provided. The scanner includes a platen, a scanning device, a track and a first elastic member. The object is placed on the platen. The scanning device is movably disposed under the platen, having a lateral side. The track supports the scanning device at the lateral side, guiding motion in axial direction of the track. The first elastic member is disposed on the lateral side, supporting the scanning device based on the track, providing a predetermined distance between the platen and the scanning device.

### BACKGROUND

The inventions relates to a scanner and in particular to a scanner with contact image sensor (CIS).

FIG. 1a shows a conventional contact image sensor (CIS) scanner, which includes an upper frame 11, a lower frame 12, a platen 13, a scan head 14, a track 15 and a driving mechanism 16. The upper frame 11 has an opening 111 therein in which the platen 13 is disposed. The scan head 14 is disposed between the upper frame 11 and the lower frame 12. A contact image sensor (not shown) is recessed in the scan head 14. The contact image sensor scans the object placed on the platen 13. The track 15 is disposed in the lower frame 12. The scan head 14 has a connecting portion 141 connected to the track 15. The driving mechanism 16 moves the scan head 14 along the track 15, completing the scan of the object.

FIG. 1b shows the structure of the scanner shown in FIG. 1a. In FIG. 1b, the connecting portion 141 is formed at the bottom of the scan head 14. Several rollers 142 are installed at the top of the scan head 14 to contact the platen 13. Meanwhile, the scan head 14 is connected to the driving mechanism 16 by a belt 161, moving the scan head 14 along the track 15.

It may be difficult to maintain a predetermined distance between the object and the contact image sensor. Any fluctuation in mechanical dimension or change in temperature can cause deformation in material and render mass production difficult.

### SUMMARY

Scanners are provided. An exemplary of a scanner comprises a platen, a scanning device, a track and a first elastic member. The object is placed on the platen. The scanning device is movably disposed under the platen, having a lateral side. The track supports the scanning device at the lateral side, guiding motion in axial direction of the track. The first elastic member is disposed on the lateral side, supporting the scanning device based on the track.

The scanning device comprises a sensor and a carriage, and the sensor for scanning the object is disposed in the carriage.

The scanner further comprises a second elastic member disposed between the carriage and the sensor, disposed near the lateral side. The second elastic member may be a compression spring.

A first contacting element is disposed on the scanning device. The first elastic member abuts the scanning device such that the first contacting element is contacted and pushed toward the platen. The first contacting element comprises material with low coefficient of friction.

A second contacting element is disposed on the scanning device. The second elastic member abuts the carriage such that the second contacting element is contacted and pushed toward the platen. The second contacting element comprises material with low coefficient of friction.

The carriage comprises a sleeve disposed on the lateral side, encircling the track.

The sensor may be a contact image sensor (CIS).

The first elastic member may be a torsion spring. One end of the torsion spring abuts the track and the other end of the torsion spring elevates the scanning device.

A driving mechanism conveys the scanning device along the track.

Another exemplary of a scanner comprises a platen, a sensor, a carriage, a first contacting element and a second contacting element. The object is placed on the platen. The carriage is movably disposed under the platen and supports the sensor. The contacting elements are disposed on the carriage, contacting the platen.

A first elastic member pushes the first contacting element toward the platen.

A track supports the carriage, guiding motion in axial direction of the track, whereby the sensor scans the object.

The first elastic member may be a torsion spring. One end of the torsion spring abuts the track and the other end of the torsion spring elevates the carriage.

A second elastic member is disposed between the carriage and the sensor, pushing the second contacting element toward the platen. The second elastic member may be a compression spring.

The first and second contacting elements may be lubricating elements.

The sensor may be a contact image sensor (CIS).

The scanner comprises a driving mechanism conveying the carriage along the track.

### DESCRIPTION OF THE DRAWINGS

FIG. 1a is a schematic diagram of a conventional scanner;

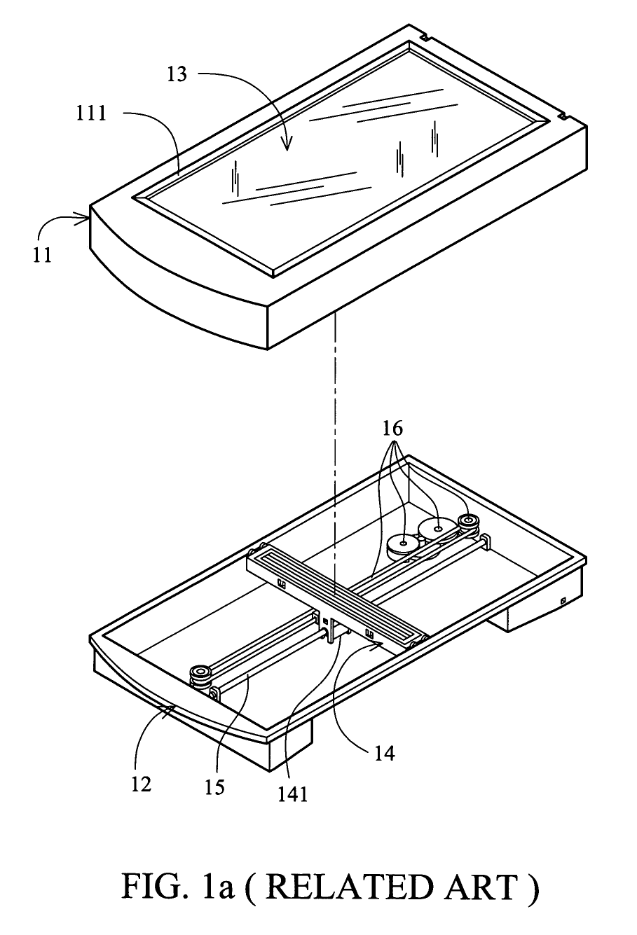

FIG. 1b is an enlarged view of the scanner according to FIG. 1a;

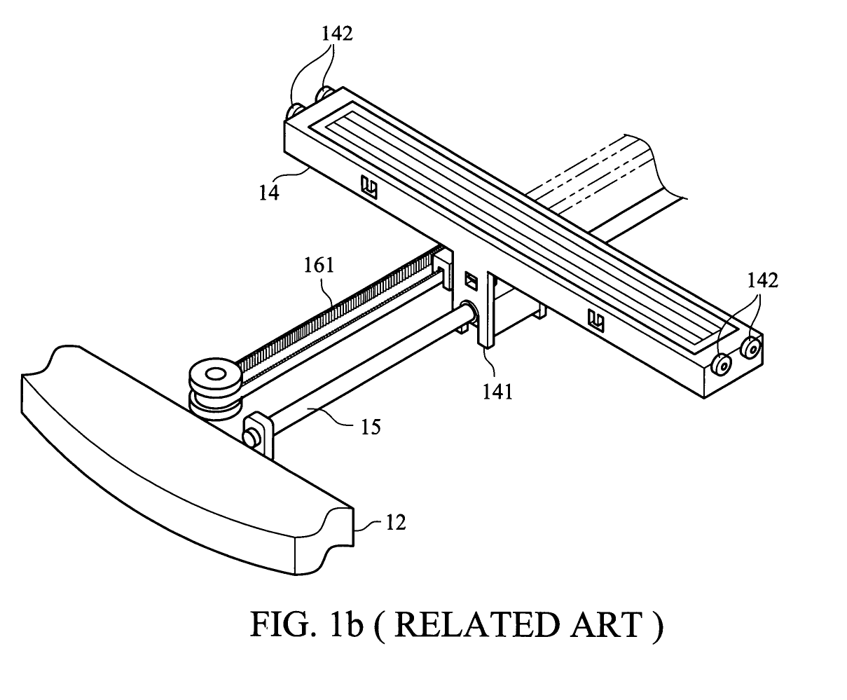

FIG. 2 is a schematic diagram of an embodiment of a scanner;

FIG. 3a is an exploded view of an embodiment of the scanner; and

FIG. 3b is a diagram of an embodiment of the scanner.

### DETAILED DESCRIPTION OF THE INVENTION

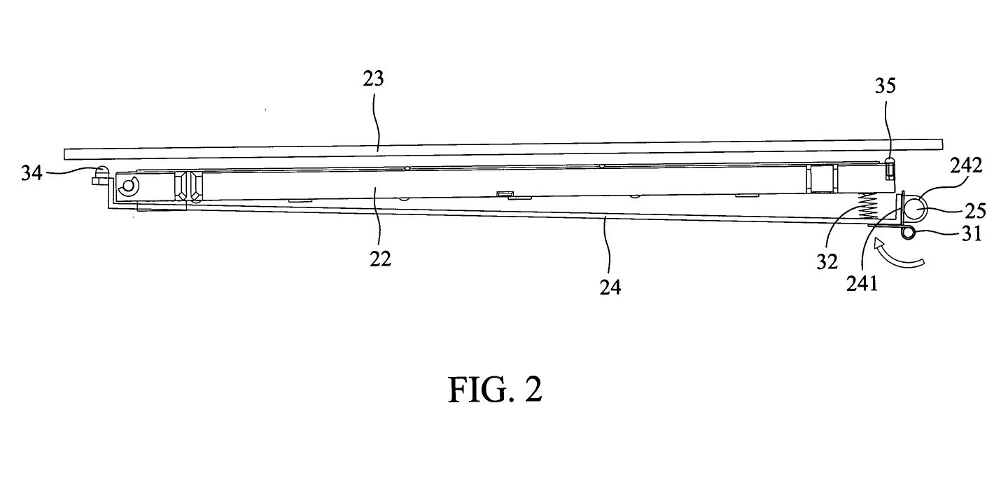

FIG. 2 shows an embodiment of a scanner. Devices and elements common with a conventional scanner are omitted. The scanner comprises a scanning device, a platen 23, a track 25, a first elastic member 31, a second elastic member 32, a first contacting element 34 and a second contacting element 35. In this embodiment, the scanning device comprises a carriage 24 and a sensor 22. The sensor can be a contact image sensor (CIS).

An object such as a document or picture is placed on the platen 23. The carriage 24 is disposed under the platen 23 and the sensor 22 disposed therein. The sensor 22 scans the object via the platen 23. The carriage 24 has a lateral side 241 with a sleeve 242 disposed thereon. The track 25 disposed on the lateral side 241 passes through the sleeve 242 to support the carriage 24. A driving mechanism (not shown) continues to drive the carriage 24 in the axial direction of the track 25, completing the scanning process.

In FIG. 2, the first elastic member 31 is disposed on the lateral side 241 supporting the carriage 24 based on the track 25. The first elastic member 31 is a torsion spring, one end of the torsion spring abuts the track 25, and the other end of the torsion spring connects to the bottom of the carriage 24. Therefore, due to the torsion of the first elastic member 31, the carriage 24 rotates according to the track 25 (as shown in FIG. 2 by an arrow), pushing the first contacting element 34 on the carriage 24 toward the platen 23. Meanwhile, the sensor 22 is fastened to the carriage 24 near the first contacting element 34.

The second elastic member 32 is disposed between the sensor 22 and the carriage 24 near the lateral side 241, and can be a compression spring. The elastic force thereof pushes the second contacting element 35 disposed on the sensor 22 toward the platen 23. Thus, the first contacting element 34 and the second contacting element 35 contact and fit to the platen 23 by the track 25 and the elastic force of the elastic members 31 and 32, such that a predetermined distance is maintained between the sensor 22 and the platen 23.

The first contacting element 34 and the second contacting element 35 mentioned can comprise a material with low coefficient of friction or lubricating elements.

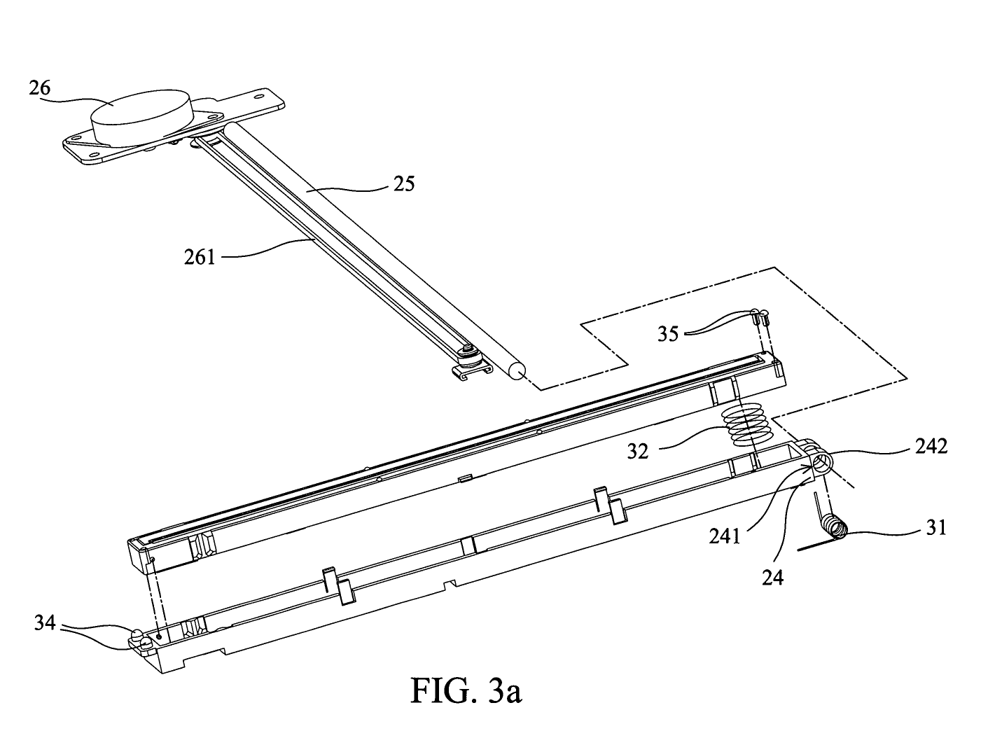

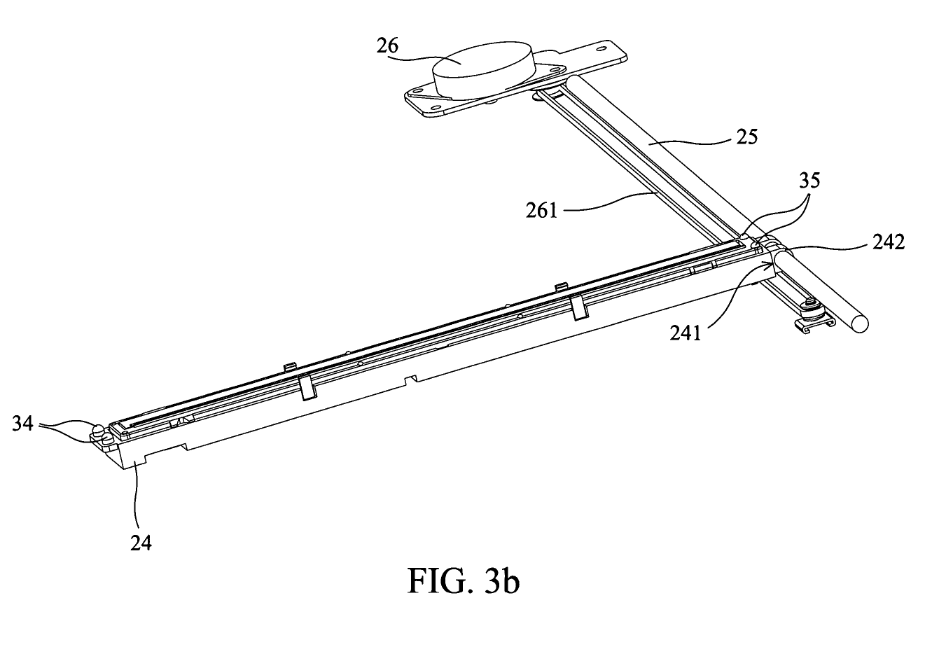

FIG. 3a is an exploded view of the scanner of the present invention, and FIG. 3b is a diagram of the scanner of the present invention.

In FIG. 3a, the sensor is received in the carriage 24. The first contacting element 34 is disposed on the carriage 24. The second contacting element 35 is disposed on the sensor 22 near the lateral side 241. The sleeve 242 is disposed on the lateral side 241 of the carriage 24. The track 25 passes through the sleeve 242 to support the carriage 24. The first elastic member 31 is disposed on the lateral side 241. One end of the first elastic member 31 connects to and abuts the track 25; the other end of the first elastic member 31 connects to the bottom of the carriage 24. The second elastic member 32 is disposed between the sensor 22 and the carriage 24 near the lateral side 241. The first contacting element 34 and the second contacting element 35 are pushed toward the platen 23 by the elastic force of the first elastic member 31 and the second elastic member 32, maintaining the distance between the sensor 22 and the platen 23, thereby maintaining the object focus of the sensor to ensure optical quality. As shown in FIG. 3a, the first elastic member 31 is a torsion spring, and the second elastic member 32 a compression spring. The first and second contacting elements 34 and 35 may comprise material with low coefficient of friction or lubricating elements.

After assembly of the scanner as shown in FIG. 3b, the carriage 24 connects the track 25 by the sleeve 242 encircling and connecting thereto. The carriage 24 is further connected to a driving mechanism 26 by a belt 261. The carriage 24 moves along the axial direction of the track 25 by the belt 261 so that the sensor 22 scans the object. The first contacting element 34 is contacting and elevating toward the platen 23 by the torsion of the first elastic member 31. The second contacting element 35 is contacting and elevating toward the platen 23 by the elastic force of the second elastic member 32.

As mentioned, the present invention provides that the track and the sleeve at a lateral side of the carriage, decreasing the volume and the size of the scanner, and the first and second elastic members maintain a predetermined distance between the sensor and the platen to maintain focus, ensuring optical quality.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A scanner, comprising:
a platen with an object placed thereon;
a scanning device movably disposed under the platen and having a lateral side;
a track for supporting the scanning device at the lateral side and for guiding motion of the scanning device in axial direction of the track; and
a first elastic member disposed at the lateral side, supporting the scanning device based on the track.

2. The scanner as claimed in claim 1, wherein the scanning device comprises a sensor and a carriage, and the sensor for scanning the object is disposed in the carriage.

3. The scanner as claimed in claim 2, further comprising a second elastic member disposed between the carriage and the sensor.

4. The scanner as claimed in claim 3, wherein the second elastic member is disposed near the lateral side.

5. The scanner as claimed in claim 4, wherein the second elastic member is a compression spring.

6. The scanner as claimed in claim 1, further comprising a first contacting element disposed on the scanning device, wherein the first elastic member abuts the scanning device so that the first contacting element contacts and is pushed toward the platen.

7. The scanner as claimed in claim 6, wherein the first contacting element comprises a material with low coefficient of friction.

8. The scanner as claimed in claim 2, further comprising a second contacting element disposed on the scanning device, wherein the second elastic member abuts the carriage so that the second contacting element contacts and is pushed toward the platen.

9. The scanner as claimed in claim 8, wherein the second contacting element comprises a material with low coefficient of friction.

10. The scanner as claimed in claim 2, wherein the carriage comprises a sleeve disposed on the lateral side and encircling the track.

11. The scanner as claimed in claim 2, wherein the sensor is a contact image sensor (CIS).

12. The scanner as claimed in claim 1, wherein the first elastic member is a torsion spring, one end of the torsion spring abutting the track, the other end of the torsion spring connecting to the scanning device to provide support thereto.

13. The scanner as claimed in claim 1, further comprising a driving mechanism connecting and driving the scanning device along the track.

14. A scanner, comprising:
a platen with an object placed thereon;
a sensor disposed under the platen to scan the object;
a carriage movably disposed under the platen and supporting the sensor;
a first contacting element disposed on the carriage and contacting the platen; and
a second contacting element disposed on the carriage and contacting the platen.

15. The scanner as claimed in claim 14, further comprising a first elastic member for pushing the first contacting element toward the platen.

16. The scanner as claimed in claim 15, further comprising a track for supporting the carriage and for guiding motion of the carriage in axial direction of the track, whereby the sensor scans the object.

17. The scanner as claimed in claim 16, wherein the first elastic member is a torsion spring, one end of the torsion spring abutting the track, the other end of the torsion spring connecting to the bottom of the carriage.

18. The scanner as claimed in claim 14, further comprising a second elastic member disposed between the carriage and the sensor, pushing the second contacting element toward the platen.

19. The scanner as claimed in claim 18, wherein the second elastic member is a compression spring.

20. The scanner as claimed in claim 14, wherein the first and second contacting elements are lubricating elements.

21. The scanner as claimed in claim 14, wherein the sensor is a contact image sensor (CIS).

22. The scanner as claimed in claim 14, further comprising a driving mechanism connecting and driving the carriage along the track.
